(19) United States
(12) Patent Application Publication
(10) Pub. No.: US 2020/0408237 A1
(43) Pub. Date: Dec. 31, 2020

(54) FASTENER

(71) Applicant: International Truck Intellectual Property Company, LLC, Lisle, IL (US)

(72) Inventors: Constantin Sebastian Busuioc, Plainfield, IL (US); Jay E. Bissontz, Spencerville, IN (US); Steven Franklin Wagester, Naperville, IL (US); Donald D. Anderson, Homer Glen, IL (US)

(73) Assignee: International Truck Intellectual Property Company, LLC, Lisle, IL (US)

(21) Appl. No.: 16/454,772

(22) Filed: Jun. 27, 2019

(51) Int. Cl. F16B 19/08

(52) U.S. Cl. CPC F16B 19/08

(57) ABSTRACT

A fastener comprises a head end and a tail end. A shaft joins the head end and the tail end. An extension extends axially from the shaft

### BACKGROUND

Embodiments disclosed herein relate generally to fastener and a method of using a fastener.

### SUMMARY

This disclosure relates to a fastener and a method of using a fastener. In one embodiment, the fastener comprises a head end and a tail end. A shaft joins the head end and the tail end. A extension extends axially from the shaft.

### DESCRIPTION OF THE DRAWINGS

FIG. 1 is a side view of one embodiment of a fastener described herein;

FIG. 2 is an end view of the fastener of FIG. 1;

FIG. 3 is an end view of the fastener of FIG. 1 opposite to an end thereof shown in FIG. 2;

FIG. 4 is a side view of the fastener of FIG. 1 applied to a bore in a workpiece, shown in section; and

FIG. 5 is a view similar to FIG. 4 with the fastener applied to a bore in a workpiece and advanced with respect to disposition shown in FIG. 4.

### DETAILED DESCRIPTION

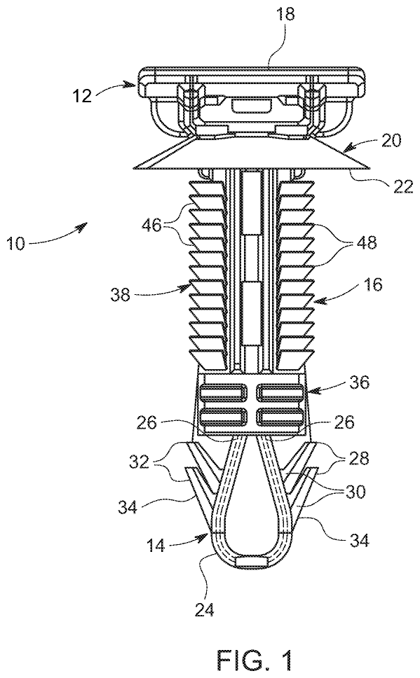

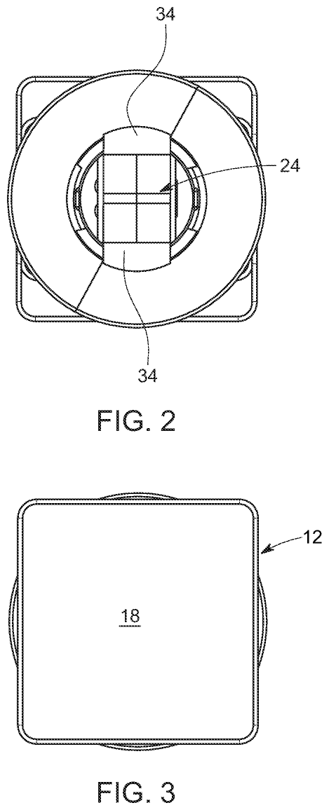

This disclosure relates to a fastener 10, one embodiment of which is shown in FIG. 1. The fastener 10 is made of any appropriate material, such as a malleable polymer or other flexible composition. The fastener 10 comprises a head end 12 and a tail end 14 joined by a shaft 16. FIG. 3 shows that the head end 12 comprises a platform 18 useful for applying force, such as from a tool, e.g. hammer and the like, to the fastener 10. Opposite to the platform 18, the head end 12 includes a frustoconical segment 20 having a bearing surface 22 that can engage a portion of a workpiece to which the fastener 10 is applied.

The tail end 14 of the fastener 10 includes an extension 24 extending substantially axially from the shaft 16. Joint 26 disposed between the shaft 16 and the extension 24 may, in some embodiments, be weakened, thereby facilitating removal of the extension 24 from the shaft 16. Depending on application of the fastener 10, the extension 24 may take a form similar to a loop, a ball, a strap, and the like. The extension 24, depending upon application of the fastener 10, may facilitate application of force to the fastener 10 enabling the fastener 10 to be “pulled” into a bore in a workpiece. In other embodiments, the extension 24 may act as an attachment point for secondary retention apparatuses such as a strap-lock, a zip tie and the like which are disposed through the extension 24 to retain secondary structures, such as wires, harnesses, hoses, lines and the like.

At least one projection 28 is disposed on an outer surface of the extension 24. In one 3 embodiment, the at least one projection 28 comprises a extension-engaging end 30 and a free end 32. The free end 32 is offset from the extension-engaging end 30 by a distance extended by a leg 34. The leg 34 extends from the extension-engaging end 30 angularly towards the joint 26.

The shaft 16 includes a preload section 36 and a load section 38. The preload section 36 has an axial length substantially similar to an axial length of a bore 40 in a workpiece 42 to which the fastener 18 is to be applied. The preload section 36 has an external diameter substantially similar to an inner diameter of the bore 40 in the workpiece 42. The load section 38 includes a plurality of annular extensions 44. Each annular extension 44 comprises a sloping surface 46 and a contacting surface 48. The sloping surfaces 46 of the annular extensions 44 define an outer diameter that increases from the outer diameter of the preload section 36 of the shaft 16, i.e. substantially similar to the inner diameter of the bore 40 in the workpiece 42, to a diameter somewhat larger than the inner diameter of the bore 40 in the workpiece 42. An outer diameter defined by the contacting surfaces 48 is somewhat larger than the inner diameter of the bore 40 in the workpiece 42. As is discussed in greater detail below, as the fastener 10 is moved from a preload position to a load position, the contacting surfaces 48 of the annular extensions 44 engage an inner diameter surface of the bore 40 in the workpiece 42.

Further details of the fastener 10 will become apparent in the following disclosure of one method of using the fastener 10.

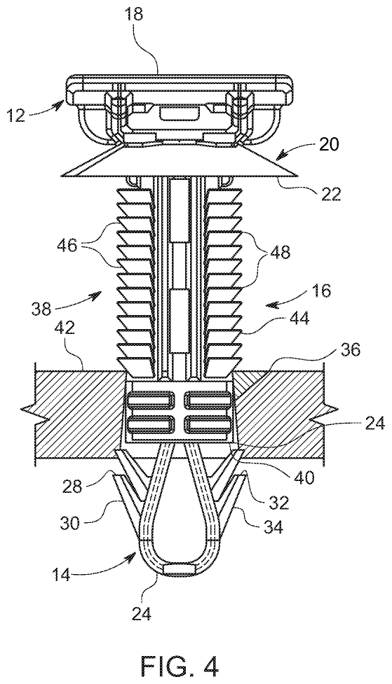

The fastener 10 is applied to a bore 40 on a workpiece 42. The extension 24 on the tail end 14 of the fastener 10 is inserted into the bore 40 on the workpiece 42. This may be done by human manipulation, with a tool and the like. The extension 24 is advanced into the bore 40 until free ends 32 of the projections 24 contact or pass beyond a terminal end 50 of the bore 40. Simultaneously, the preload section 36 of the shaft 16 of the fastener 10 is disposed within the bore 40. This is shown in FIG. 4. This is a preload position.

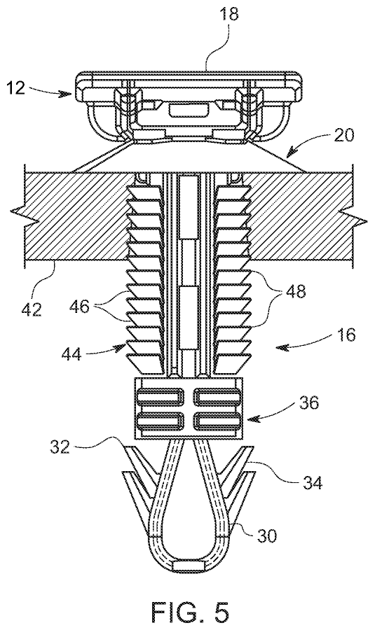

At that point, a force is applied to the extension 24 on the tail end 14 of the fastener 10. This force may be applied by any appropriate means, such a hook, a strap and the like, that encourages the fastener 10 axially through the bore 40, i.e. the fastener 10 is pulled into the bore 40. The force is applied until the bearing surface 22 on the head end 12 of the fastener 10 engages the workpiece 40. This is shown in FIG. 5. This is the load position of the fattener 10.

What is claimed is:

1. A fastener comprising:
a head end;
a tail end;
a shaft joining the head end and the tail end; and
an extension extending axially from the shaft.

2. A fastener as defined in claim 1 further comprising:
a platform comprising the head end.

3. A fastener as defined in claim 1 further comprising:
a bearing surface disposed on the head end.

4. A fastener as defined in claim 1 further comprising:
a joint disposed between the shaft and the extension, wherein the joint is weakened.

5. A fastener as defined in claim 1 further comprising:
a projection disposed on the extension.
